(19) United States
(12) Patent Application Publication
(10) Pub. No.: US 2020/0356875 A1
(43) Pub. Date: Nov. 12, 2020

(54) MODEL TRAINING

(71) Applicant: Beijing Sankuai Online Technology Co., Ltd, Beijing (CN)

(72) Inventor: Ziwei WANG, Beijing (CN)

(21) Appl. No.: 16/768,074

(22) PCT Filed: Oct. 18, 2018
(86) PCT No.: PCT/CN2018/110872

§ 371 Date: May 28, 2020

(30) Foreign Application Priority Data
Dec. 11, 2017 (CN) 201711308334.5

(51) Int. Cl. G06N 5/04; G06N 20/00

(52) U.S. Cl. CPC G06N 5/04; G06N 20/00

(57) ABSTRACT

Provided in various embodiments are a model training method and apparatus, an electronic device and a computer readable storage medium, belonging to the technical field of computers. In those embodiments, at least one sample subset can be obtained according to a sample set configured to train models. For each of the sample subsets, a plurality of machine learning models can be trained corresponding to the sample subset according to the sample subset, and predicted values of the plurality of machine learning models can be obtained for the sample subset. A fusion sample set can then be determined according to the predicted values of the machine learning models for each of the sample subsets, and a target machine learning model can be trained according to the fusion sample set.

### CROSS-REFERENCE TO RELATED APPLICATIONS

This patent application claims priority to Chinese Patent Application No. 201711308334.5, filed on Dec. 11, 2017 and entitled “Model Training Method and Apparatus, and Electronic Device”, which is incorporated herein by reference in its entirety.

### TECHNICAL FIELD

The present disclosure relates to the technical field of computers, and more particularly, to a model training method and apparatus, and an electronic device.

### BACKGROUND

As the quantity of platform data increases, the use of the platform data becomes particularly important. For example, modeling is performed through the platform data, and models trained in advance are used to predict user behaviors or provide data that users are interested in. A relatively common method is to train a model in advance and predict real-time data through the trained model. Further, in order to improve the accuracy of the predicted data, a plurality of models may be trained in advance, then, data prediction is respectively performed through each model, and finally, the predicted results are fused. For example, by weighting and summing the predicted scores of all models, a final predicted score for the real-time data is obtained. When a single model is trained, preset dimension features of the platform data may be directly extracted, and then, the model is trained based on a support vector machine (SVM) classifier or a neural network model.

### SUMMARY

Various embodiments can provide a model training method to improve the accuracy of predicted results when models trained by the model training method are applied to data mining, data searching, and the like.

In order to solve the above problems, in a first aspect, one embodiment provides a model training method, including: obtaining at least one sample subset according to a sample set; for each of the sample subsets, respectively training a plurality of machine learning models corresponding to the sample subset according to the sample subset, and obtaining predicted values of the plurality of machine learning models for the sample subset; determining a fusion sample set according to the predicted values of the machine learning models for each of the sample subsets; and training a target machine learning model according to the fusion sample set.

In a second aspect, one embodiment provides a model training apparatus, including: a sampling module, configured to obtain at least one sample subset according to a sample set; a single model training and prediction module, configured to respectively train a plurality of machine learning models corresponding to each of the sample subsets according to the sample subset, and obtain predicted values of the plurality of machine learning models for the sample subset; a sample feature fusion module, configured to determine a fusion sample set according to the predicted values of the machine learning models for each of the sample subsets; and a target machine model training module, configured to train a target machine learning model according to the fusion sample set determined by the sample feature fusion module.

In a third aspect, one embodiment further provides an electronic device, including a memory, a processor and a computer program stored on the memory and capable of running on the processor. When the processor executes the computer program, the model training method according to the embodiment of the present application is implemented.

In a fourth aspect, one embodiment provides a computer readable storage medium. A computer program is stored on the computer readable storage medium. When the program is executed by a processor, the steps of the model training method disclosed by the embodiment of the present application are implemented.

According to the model training method in accordance with one embodiment, at least one sample subset is obtained according to a sample set; and then, for each of the sample subsets, a plurality of machine learning models corresponding to the sample subset are respectively trained according to the sample subset, and predicted values of the plurality of machine learning models for the sample subset are obtained; a fusion sample set is determined according to the predicted values of the machine learning models for each of the sample subsets; and finally, a target machine learning model is trained according to the fusion sample set, thereby effectively improving the accuracy of the predicted results when the models trained by the model training method are applied to data mining, data searching, and the like. According to the model training method disclosed by the embodiment of the present application, a sample set is divided into a plurality of sample subsets to train different machine learning models, and then, the predicted result of the model obtained by previous training on the training data is taken as the feature of the training data to further perform model training, thereby effectively avoiding the problem of inaccurate predicted result of the model obtained by training due to a single training model or uneven training data distribution, and effectively improving the accuracy of the prediction effect of the model obtained by training.

### BRIEF DESCRIPTION OF THE DRAWINGS

To describe the technical solutions in the embodiments of the present application more clearly, the following briefly introduces the accompanying drawings required for describing the embodiments or the prior art. Apparently, the accompanying drawings in the following description show merely some embodiments of this application, and a person of ordinary skill in the art may still derive other drawings from these accompanying drawings without creative efforts.

FIG. 1 is a flow diagram of a model training method according to some embodiment I of the present application.

FIG. 2 is a flow diagram of a model training method according to some embodiment II of the present application.

FIG. 3 is a schematic diagram of training of a plurality of single models according to Embodiment II of the present application.

FIG. 4 is a schematic structural diagram I of a model training apparatus according to an Embodiment III of the present application.

FIG. 5 is a schematic structural diagram II of the model training apparatus according to Embodiment III of the present application.

FIG. 6 is a schematic structural diagram III of the model training apparatus according to Embodiment III of the present application.

### DETAILED DESCRIPTION OF THE EMBODIMENTS

The following clearly and completely describes the technical solutions in various embodiments with reference to the accompanying drawings in the embodiments of this application. Apparently, the described embodiments are some embodiments in accordance with the disclosure rather than all of the embodiments. All other embodiments obtained by a person of ordinary skill in the art based on the embodiments of the present application without creative efforts shall fall within the protection scope of this application.

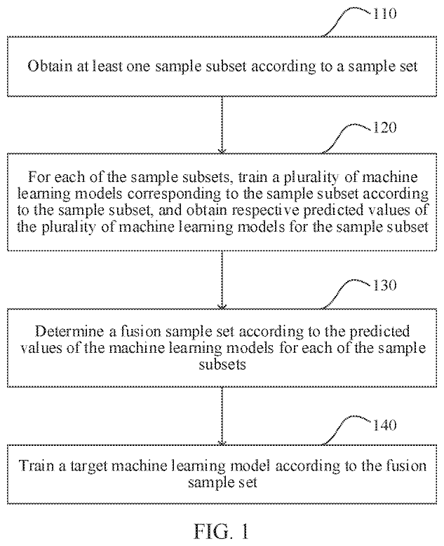

In one embodiment, a model training method in provided. As shown in FIG. 1, the model training method can include steps 110 to 140.

In step 110, at least one sample subset is obtained according to a sample set.

Samples for training models usually include: labels and features of preset dimensions. The features of the preset dimensions may be correspondingly selected according to source data and different application scenes of the models to be trained. Taking the prediction of the purchase rate of a user as an example, the features of the preset dimensions may include: user's gender, age, occupation, place of residence, commodity category, price, purchase frequency, etc. The larger the number of samples for training the models, the more accurate the predicted results obtained from the trained models. During specific implementation of the present application, firstly, the sample set is sampled to obtain a plurality of sample subsets to respectively train different machine learning models. For example, 80% of the samples in the sample set are randomly selected to form the sample subset.

In step 120, for each of the sample subsets, a plurality of machine learning models corresponding to the sample subset are trained according to the sample subset, and respective predicted values of the plurality of machine learning models for the sample subset are obtained.

In order to further improve the accuracy of the predicted results obtained from the trained models, the present application uses an iteration training method to train the target model. M machine learning models are preset. In this case, firstly, the M machine learning models are respectively trained through the at least one sample subset. Then, the trained models are used to predict the sample set, and the obtained predicted values are used as the features of the samples in the sample set, thereby generating new training data. Thus, the new training data may be used to further train the preset machine learning models. M is an integer greater than 1. In the embodiment of the present application, M=5 is taken as an example to explain model training processes in detail. The M machine learning models may be the same or different. The machine learning models may be any one or more of a logistic regression model, a random forest model, a Bayesian method model, an SVM model, and a neural network model, or other models.

During example implementation, firstly, at least one sample subset is respectively taken as the input of M machine learning models, and training is performed to obtain M machine learning models corresponding to each of the sample subsets. Then, the M machine learning models corresponding to each of the sample subsets are used to predict the sample subset respectively to obtain M groups of predicted values corresponding to the sample subset. Each group of predicted values includes a predicted value obtained by using a machine learning model to predict each piece of sample data in the sample subset. In the case of N sample subsets and M machine learning models, N*M groups of predicted values will be obtained, where N and M are integers greater than 1.

In step 130, a fusion sample set is determined according to the predicted values of the machine learning models for each of the sample subsets.

During example implementation, the N*M groups of predicted values obtained in the above step include: predicted values obtained by predicting each piece of sample data in the 1st sample subset respectively by the M machine learning models, predicted values obtained by predicting each piece of sample data in the 2nd sample subset respectively by the M machine learning models, . . . , and predicted values obtained by predicting each piece of sample data in the Nth sample subset respectively by the M machine learning models. That is, if a sample is sampled into N sample subsets, N*M predicted values will be obtained for the sample. During specific implementation, the N*M predicted values are taken as features of the sample data to generate a fusion sample corresponding to the sample, so as to train machine learning models subsequently.

In step 140, a target machine learning model is trained according to the fusion sample set.

By taking the predicted values of the machine learning models corresponding to the sample subset for the sample subset as the features of the samples in the sample subset, after the fusion sample set is generated, each sample in the fusion sample set will have features of an N*M dimension, and labels will remain unchanged; and then, the target machine learning model is trained according to the fusion sample set.

According to the model training method in accordance with this embodiment, at least one sample subset is obtained by sampling a sample set; and then, a plurality of machine learning models corresponding to each of the sample subsets are respectively trained according to each of the sample subsets, predicted values of the corresponding machine learning models for each of the sample subsets are obtained, and a fusion sample set is generated according to the predicted values. Thus, a target machine learning model may be trained according to the fusion sample set, thereby improving the accuracy of the predicted result when the target machine learning model is applied to data mining, data searching, and the like. According to the model training method disclosed by the embodiment of the present application, a sample set is divided into a plurality of parts to train different machine learning models, and then, the predicted result of the model obtained by previous training is taken as the feature of the training data to further perform training, thereby effectively avoiding the problem of inaccurate predicted result of the model due to a single training model or uneven training data distribution, and effectively improving the accuracy of the prediction effect of the model.

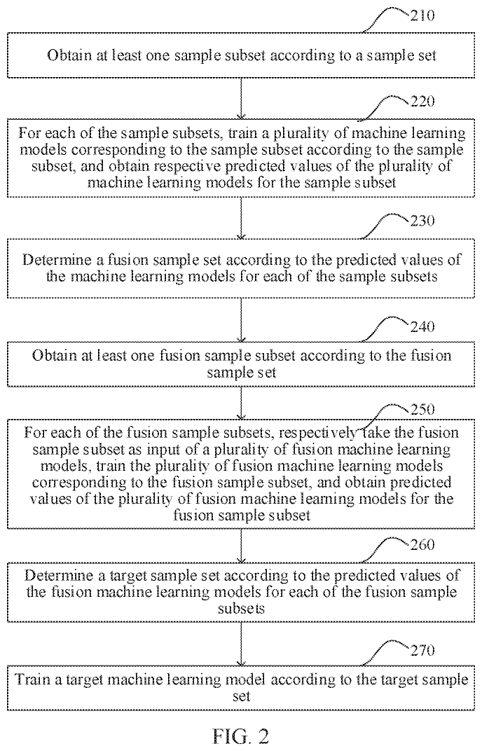

Another model training method is provided by an embodiment shown in FIG. 2. The model training method can include steps 210 to 270.

In step 210, at least one sample subset is obtained according to a sample set.

The larger the number of samples for training the models, the more accurate the predicted results obtained from the trained models. During example implementation of the present application, firstly, the sample set is sampled to obtain a plurality of sample subsets to respectively train different machine learning models. During example implementation, obtaining N sample subsets according to the sample set includes: performing random sampling on the sample set to obtain N sample subsets; and performing feature sampling on each sample subset. Assuming that the sample set has a total of 10000 samples, to obtain 10 sample subsets, 80% of the samples in the sample set may be randomly selected to form the sample subset, and then, each sample subset includes 8000 samples, where N is an integer greater than 1.

Samples for training models usually include: labels and features of preset dimensions. The features of the preset dimensions may be correspondingly selected according to source data and different application scenes of the models to be trained. Then, feature sampling is performed on each sample. During specific implementation, in order to improve the difference of the trained models and improve the prediction accuracy, feature sampling may be performed on each sample subset. For example, features of some dimensions of samples in the sample subset are randomly selected for training and prediction, and features of other dimensions of the samples are deleted. Taking the prediction of the purchase rate of a user as an example, when machine learning models are trained for the first time, the features of the preset dimensions may include: user's gender, age, occupation, place of residence, commodity category, price, purchase frequency, etc. When feature sampling is performed on the sample subset, the features of the samples in a first sample subset may include gender, place of residence, and commodity category; and the features of the samples in a second sample subset may include gender, occupation, and price. By performing feature sampling on the sample subset, the difference of the trained models is further increased. Taking a sample item1 as an example, when machine learning models are trained for the first time, the features of the sample item1 are the features of the preset dimensions extracted from platform raw data, as shown in the following table:

| Sample | Label | Feature 1 | Feature 2 | Feature 3 | Feature 4 | . . . |
|---|---|---|---|---|---|---|
| item1 | 1 | 149901204 | 1002423 | 26.776 | 14 | . . . |

In step 220, for each of the sample subsets, a plurality of machine learning models corresponding to the sample subset are trained according to the sample subset, and respective predicted values of the plurality of machine learning models for the sample subset are obtained.

For example, the plurality of machine learning models are different types of machine learning models.

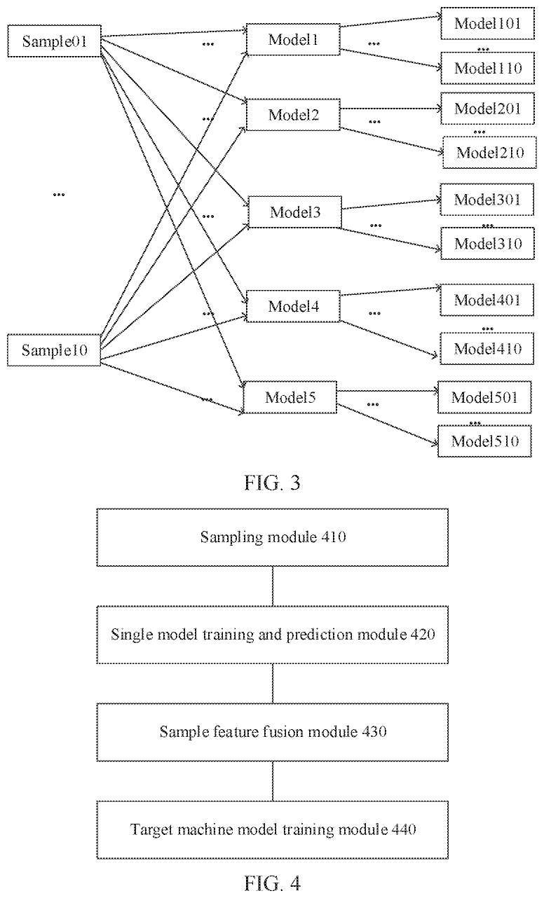

In the present embodiment, 5 machine learning models are trained, that is, M=5 is taken as an example to explain model training processes in detail. As shown in FIG. 3, assuming that M machine learning models are respectively; a logistic regression model Model1, a random forest model Model2, a Bayesian method model Model3, an SVM model Model4, and a neural network model Model5. Assuming that after the sample set is sampled, 10 sample subsets are obtained and are respectively marked as: Sample01, Sample02, Sample03, Sample04, Sample05, Sample06, Sample07 Sample08, Sample09, and Sample10. Thus, during specific implementation, the sample subset Sample01 is respectively taken as input of the models Model1 to Model5, and then, the models Model1 to Model5 are respectively trained based on the sample subset Sample01, so as to obtain 5 machine learning models corresponding to the sample subset Sample01, which are respectively marked as: a logistic regression model Model101, a random forest model Model201, a Bayesian method model Model301, an SVM model Model401, and a neural network model Model501. In a similar way, the sample subsets Sample02 to Sample10 are respectively taken as input of the models Model1 to Model5, and then, the models Model1 to Model5 are respectively trained based on the sample subsets Sample02 to Sample10. By taking each sample subset as input of 5 machine learning models respectively, 5 machine learning models corresponding to each sample subset may be obtained by training, and 50 machine learning models will be obtained in total, where each sample subset corresponds to 5 machine learning models.

Then, for each sample subset, the sample subset is predicted respectively through the 5 machine learning models corresponding to the sample subset, so as to obtain 5 groups of predicted values of the sample subset. For example, the sample subset Sample01 is predicted respectively through the logistic regression model Model101, the random forest model Model201, the Bayesian method model Model301, the SVM model Model401, and the neural network model Model501, so as to obtain respective predicted values of the 5 machine learning models for the sample subset Sample01.

During example implementation, training the plurality of machine learning models corresponding to each of the sample subsets according to the sample subset, and obtaining respective predicted values of the plurality of machine learning models for the sample subset include: respectively taking the sample subset as input of the plurality of machine learning models, training the plurality of machine learning models corresponding to the sample subset through a K-fold cross-validation method, and obtaining respective predicted values of the plurality of trained machine learning models for the sample subset. In the embodiment of the present application, K=5 and M=5 are taken as examples to explain a specific solution of respectively taking a sample subset as input of 5 machine learning models and training 5 machine learning models corresponding to the sample subset through a 5-fold cross-validation method in detail.

During example implementation, respectively taking each of the sample subsets as input of the plurality of machine learning models, training the plurality of machine learning models corresponding to each of the sample subsets through the K-fold cross-validation method, and obtaining respective predicted values of the plurality of machine learning models corresponding to each of the sample subsets for the sample subset include: for each sample subset, respectively taking the sample subset as input of the plurality of machine learning models to train the plurality of machine learning models corresponding to the sample subset; and for each sample subset, respectively predicting the sample subset through the plurality of machine learning models corresponding to the sample subset, so as to obtain respective predicted values of the plurality of machine learning models corresponding to the sample subset for the sample subset.

Training the specified machine learning model corresponding to the currently concerned sample subset further includes: randomly dividing the sample subset into K subsets, selecting one of the K subsets as a test set every time and taking the remaining K-1 subsets as training sets corresponding to the test set, and respectively training the specified machine learning model based on the training sets, so as to obtain K submodels of the specified machine learning model corresponding to the sample subset. Taking the sample subset Sample01 as the currently concerned sample subset and specifying the model as a logistic regression model, firstly, the sample subset Sample01 is evenly divided into 5 subsets, respectively marked as D1, D2, D3, D4, and D5. For the first time, the subset D1 is selected as a test set and the subsets D2 to D5 are selected as training sets corresponding to the test set D1, a logistic regression model is trained based on the training sets D2 to D5, and the trained logistic regression model is marked as Model101-1. The logistic regression model Model101-1 is obtained by training based on a part of samples in the sample subset Sample01, that is, it corresponds to the sample subset Sample01. For the second time, the subset D2 is selected as a test set and the subsets D1 and D3 to D5 are selected as training sets corresponding to the test set D2, a logistic regression model is trained based on the training sets D1 and D3 to D5, and the trained logistic regression model is marked as Model1012. The logistic regression model Model1012 is obtained by training based on a part of samples in the sample subset Sample01, that is, it corresponds to the sample subset Sample01. According to this method, the logistic regression models Model1011, Model1012, Model1013, Model1014, and Model1015 corresponding to the sample subset Sample01 may be sequentially obtained by training. The test sets corresponding to the logistic regression models Model1011, Model1012, Model1013, Model1014, and Model1015 are respectively subsets D1, D2, D3, D4, and D5. The logistic regression models Model1011, Model1012, Model1013, Model1014, and Model1015 may also be referred to as submodels of the logistic regression model Model101.

Then, specifying a machine learning model corresponding to the sample subset and predicting the sample subset to obtain the predicted result of the machine learning model corresponding to the sample subset for the sample subset include: determining K submodels of the machine learning model corresponding to the sample subset; for each of the submodels, predicting the test set corresponding to the submodel by using the submodel, so as to obtain the predicted value of the submodel for the sample subset, where the test set corresponding to the submodel is a test set corresponding to the training set used to train the submodel; and fusing the predicted values of the K submodels for the sample subset to obtain the predicted value of the machine learning model for the sample subset.

Taking the sample subset Sample01 as an example, when the sample subset Sample01 is predicted through the logistic regression model Model101 corresponding to the sample subset Sample0l, firstly, 5 submodels, namely the models Model1011, Model1012, Model1013, Model1014, and Model1015, of the logistic regression model Model10 corresponding to the sample subset Sample01 are determined. Then, the test set D1 is predicted through the logistic regression model Model1011, so as to obtain the predicted value for each sample in the test set D1; the test set D2 is predicted through the logistic regression model Model102, so as to obtain the predicted value for each sample in the test set D2; the test set D3 is predicted through the logistic regression model Model1013, so as to obtain the predicted value for each sample in the test set D3; the test set D4 is predicted through the logistic regression model Model1014, so as to obtain the predicted value for each sample in the test set D4; and the test set D5 is predicted through the logistic regression model Model1015, so as to obtain the predicted value for each sample in the test set D5. The predicted values for all samples in the test sets D1, D2, D3, D4, and D5 form the predicted values of the logistic regression model Model101 for the sample subset Sample01.

According to this method, the predicted values of the machine learning models Model201. Model301, Model401, and Model501 corresponding to the sample subset Sample01 for the sample subset Sample01 may be obtained respectively.

The above operations are respectively performed on different sample subsets to obtain 5 machine learning models corresponding to each sample subset, and respective predicted values of the 5 machine learning models corresponding to each sample subset for the sample subset. The predicted values of the machine learning models for the sample subset are composed of the predicted values of the machine model for each sample in the sample subset.

In step 230, a fusion sample set is determined according to the predicted values of the machine learning models for each of the sample subsets.

Determining the fusion sample set according to the predicted values of the machine learning models for each of the sample subsets includes: for each sample in the sample set, taking the predicted value of each machine learning model for the sample as a feature value of the corresponding dimension of the sample, so as to obtain a fusion sample corresponding to the sample. When each sample in the sample set is sampled into at least one sample subset, the predicted values obtained by predicting the sample through the M machine learning models corresponding to the at least one sample subset may be used as the feature values of the corresponding dimension of the fusion sample corresponding to the sample. During specific implementation of the present application, feature fusion is performed on the samples to obtain N*M-dimension features of each fusion sample.

Taking the sample item1 as an example, assuming that each of the 10 sample subsets Sample01 to Sample10 obtained by sampling includes the sample item1, the sample item1 will be used for: machine learning models Model101, Model201, Model301, Model401, and Model501 corresponding to the sample subset Sample01; machine learning models Model102, Model202, Model302, Model402, and Model502 corresponding to the sample subset Sample02; . . . , and machine learning models Model110, Model210, Model310. Model410, and Model510 corresponding to the sample subset Sample10. The sample item1 is predicted respectively through the above machine learning models to obtain corresponding predicted values. During specific implementation, the predicted values obtained by predicting the sample item1 respectively through the above machine learning models are arrayed according to preset dimension positions, so as to obtain features of a fusion sample item1 corresponding to the sample item1. For example, the predicted values obtained by predicting the sample item1 by using the machine learning models corresponding to the sample subset Sample01 are taken as the first 5 dimension features of the fusion sample item1′; and the predicted values obtained by predicting the sample item1 through the machine learning models corresponding to the sample subset Sample02 are taken as the 6th to 10th dimension features of the fusion sample item1′. By virtue of sequential arrangement, the features of all dimensions of the fusion sample item1′ may be obtained. The label of the fusion sample item1′ is the same as the label of the corresponding sample item1.

Taking the sample item2 as an example, assuming that the sample item2 is sampled into the sample subsets Sample01 and Sample02, the sample item2 will be used for: machine learning models Model101, Model201, Model301, Model401, and Model501 corresponding to the sample subset Sample01; and machine learning models Model102, Model202, Model302, Model402, and Model502 corresponding to the sample subset Sample02. The sample item2 is predicted respectively through the above machine learning models to obtain corresponding predicted values. During specific implementation, firstly, the feature values of all dimensions of the fusion sample item2′ corresponding to the sample item2 may be set to be null, such as 0; and then, the predicted values obtained by predicting the sample item2 respectively through the above machine learning models are assigned according to the preset dimension positions, thereby obtaining the features of all dimensions of the fusion sample item2. For example, the predicted value obtained by predicting the sample item2 through the machine learning model Model102 is assigned to the first dimension feature of the fusion sample item2′, the predicted value obtained by predicting the sample item2 through the machine learning model Model202 is assigned to the second dimension feature of the fusion sample item2′, and so on.

After feature fusion, taking the samples item1 and item2 as examples, when the machine learning models are trained for the first time, the features of the samples item1 and item2 are the features of the preset dimensions extracted from the platform raw data, and the features of all dimensions of the fusion sample are the predicted values of the trained machine learning models for the sample, as shown in the following table:

| Sample | Label | Feature 1 | Feature 2 | Feature 3 | Feature 4 | . . . |
|---|---|---|---|---|---|---|
| item1 | 1 | 0.8 | 0.7 | 0.7 | 0.6 | . . . |
| item2 | 0 | 0.2 | 0.1 | 0.1 | 0.1 | . . . |

Training the target machine learning model according to the fusion sample set after the fusion sample set is determined includes: obtaining at least one fusion sample subset according to the fusion sample set; for each of the fusion sample subsets, respectively taking the fusion sample subset as input of a plurality of fusion machine learning models, training the plurality of fusion machine learning models corresponding to the fusion sample subset, and obtaining respective predicted values of the plurality of fusion machine learning models for the fusion sample subset; determining a target sample set according to the predicted values of the fusion machine learning models corresponding to each of the fusion sample subsets for the fusion sample subset; and training a target machine learning model according to the target sample set.

In step 240, at least one fusion sample subset is obtained according to the fusion sample set.

The example implementation manner of obtaining at least one fusion sample subset according to the fusion sample set is substantially the same as the specific implementation manner of obtaining at least one sample subset by sampling the sample set in step 210, and the details are not described here.

In step 250, for each of the fusion sample subsets, the fusion sample subset is respectively taken as input of a plurality of fusion machine learning models, the plurality of fusion machine learning models corresponding to the fusion sample subset are trained, and predicted values of the plurality of fusion machine learning models for the fusion sample subset are obtained.

For each of the fusion sample subsets, respectively taking the fusion sample subset as input of the plurality of fusion machine learning models, training the plurality of fusion machine learning models corresponding to the fusion sample subset, and obtaining the predicted values of the plurality of fusion machine learning models for the fusion sample subset include: for each of the fusion sample subsets, respectively taking the fusion sample subset as input of the plurality of fusion machine learning models, training the plurality of fusion machine learning models corresponding to the fusion sample subset through a K-fold cross-validation method, and obtaining respective predicted values of the plurality of trained fusion machine learning models for the fusion sample subset. For the specific implementation manner of training the plurality of fusion machine learning models corresponding to each of the fusion sample subsets through the K-fold cross-validation method, reference may be made to step 220, and the details are not described here. During specific implementation, the number and types of the trained fusion machine learning models may be the same as or different from the number and types of the trained machine learning models in step 220.

In step 260, a target sample set is determined according to the predicted values of the fusion machine learning models for each of the fusion sample subsets.

After the predicted values of the fusion machine learning models for each fusion sample are determined, the target sample set may be generated according to the predicted values. During specific implementation, for each fusion sample, the predicted values of each fusion machine learning model for the fusion sample are fused to be taken as the features of the target sample corresponding to the fusion sample. For a specific solution of generating the target sample set according to the predicted values of the fusion machine learning models for the fusion sample set, reference may be made to the specific solution of generating the fusion sample set according to the predicted values of the machine learning models for the sample set, and the details are not described here.

In step 270, a target machine learning model is trained according to the target sample set.

After the target sample corresponding to the fusion sample is generated by taking the predicted values of the fusion machine learning models for the fusion sample as the features of the fusion sample, each target sample has a multi-dimensional feature, and the label is the same as the label of the corresponding fusion sample. Then, the target machine learning model is trained through the target sample set. During specific implementation, the target machine learning model may be selected from the plurality of machine learning models, or may be other machine learning models.

After the training of the target machine learning model is completed, the test data may be further predicted through the trained target machine learning model. Firstly, the data to be predicted is predicted through the trained machine learning model corresponding to each sample subset, so as to obtain the predicted value of each machine learning model for the data to be predicted. For example, the sample to be predicted is predicted respectively through N*M machine learning models corresponding to the above N sample subsets. Then, the obtained N*M predicted values are taken as the features of the N*M dimension of the sample to be predicted to be input into the target machine learning model, so as to obtain final predicted values of the sample to be predicted.

During example implementation, when the machine learning model corresponding to each sample subset is trained, the features of the sample subset, input into the machine learning model, are recorded as the input feature dimension of the machine learning model corresponding to the sample subset. When the data to be predicted is predicted through the trained machine learning model, the features of the data to be predicted need to be extracted according to the input feature dimension of the machine learning model, and then, the extracted features are input into the machine learning model to obtain a predicted value of the machine learning model for the data to be predicted.

During example implementation, in order to further improve the prediction effect of the model, the number of times of fusion model training may be set according to actual needs, so as to perform fusion model training for one time or many times. For example, at least one iteration of fusion model training is performed, that is, the number of iterations is set to be 1.

In some embodiments, before the step of determining the target sample set according to the predicted values of the fusion machine learning models for each of the fusion sample subsets, the model training method further includes: if the number of times of training the fusion machine learning models is less than a preset value, returning to step 240 of obtaining at least one fusion sample subset according to the fusion sample set, so as to perform the iteration of fusion model training; and if the number of times of training the fusion machine learning models is greater than or equal to the preset value, proceeding to step 260 of determining the target sample set according to the predicted values of the fusion machine learning models for each of the fusion sample subsets. For example, when the preset value is equal to 2, after steps 210 to 250 are performed, only 1 times of fusion model training is performed, that is, the number of times of training the fusion machine learning models is less than the preset value, and then, the flow jumps to step 240, and steps 240 and 250 are performed again, so as to perform fusion model training once again. After 2 times of fusion machine learning model training, the flow proceeds to step 260 to determine the target sample set according to the predicted values of the fusion machine learning models for each of the fusion sample subsets.

According to the model training method in accordance with this embodiment, N sample subsets are obtained by sampling a sample set; then, for each of the sample subsets, a plurality of machine learning models corresponding to the sample subset are respectively trained according to the sample subset, and respective predicted values of the plurality of machine learning models for the sample subset are obtained; a fusion sample set is determined according to the predicted values of the machine learning models for each of the sample subsets, and a certain number of iterations of fusion machine learning model training are performed: and finally, the target sample set is determined according to the predicted value of the fusion machine learning model obtained by last training for the fusion sample set, and a target machine learning model is trained based on the target sample set. When the trained models are applied to data mining, data searching, and the like, the predicted result is more accurate. According to the model training method disclosed by the embodiment of the present application, a sample set is divided into a plurality of subsets to train different machine learning models, and then, the predicted result of the model obtained by previous training on the training data is taken as the feature of the training data to further perform training, thereby effectively avoiding the problem of inaccurate predicted result of the model obtained by training due to a single training model or uneven training data distribution, and effectively improving the accuracy of the prediction effect of the model obtained by training.

A single machine learning model is trained through K-fold cross-validation to obtain the predicted values of the single machine learning model for the training data and the predicted values of the single machine learning model for test data, and then, feature fusion is performed on the training data based on the obtained predicted values, thereby improving the accuracy of the predicted result of the target machine learning model.

By performing a certain depth of iteration training, the problem of inaccurate prediction of the model obtained by training due to a single model may be further avoided, and the prediction effect of the model may be further improved.

A model training apparatus in accordance with one embodiment is provided in FIG. 4.

The model training apparatus can include:

a sampling module 410, configured to obtain at least one sample subset according to a sample set;

a single model training and prediction module 420, configured to train a plurality of machine learning models corresponding to each of the sample subsets according to the sample subset, and obtain respective predicted values of the plurality of machine learning models for the sample subset;

a sample feature fusion module 430, configured to determine a fusion sample set according to the predicted values of the machine learning models for each of the sample subsets; and

a target machine model training module 440, configured to train a target machine learning model according to the fusion sample set determined by the sample feature fusion module 430.

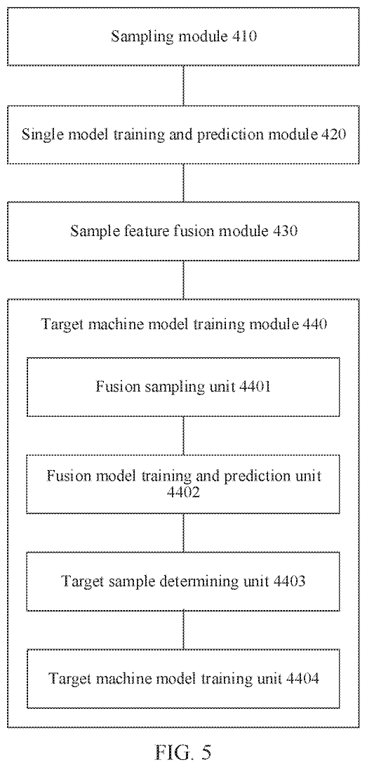

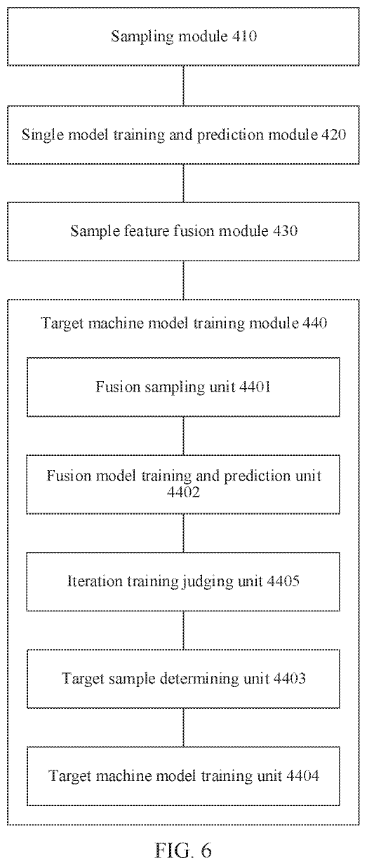

In some embodiments, as shown in FIG. 5, the target machine model training module 440 further includes:

a fusion sampling unit 4401, configured to obtain at least one fusion sample subset according to the fusion sample set;

a fusion model training and prediction unit 4402, configured to respectively take each of the fusion sample subsets as input of a plurality of fusion machine learning models, train the plurality of fusion machine learning models corresponding to the fusion sample subset, and obtain predicted values of the plurality of fusion machine learning models for the fusion sample subset:

a target sample determining unit 4403, configured to determine a target sample set according to the predicted values of the fusion machine learning models for each of the fusion sample subsets; and

a target machine model training unit 4404, configured to train a target machine learning model according to the target sample set.

In some embodiments, as shown in FIG. 6, the target machine model training module 440 further includes an iteration training judging unit 4405 configured to repeatedly call the fusion sampling unit 4401 and the fusion model training and prediction unit 4402 if the number of times of training the fusion machine learning models is less than a preset value, so as to perform iteration of fusion machine learning model training, and transfer to the target sample determining unit 4403 if the number of iterations of training the fusion machine learning models is greater than or equal to the preset value.

In some embodiments, the single model training and prediction module 420 may be further configured to: respectively take the sample subset as input of the plurality of machine learning models, train the plurality of machine learning models corresponding to the sample subset through a K-fold cross-validation method, and obtain the predicted values of the plurality of machine learning models for the sample subset.

For a specific implementation manner of respectively taking the sample subset as input of the plurality of machine learning models, training the plurality of machine learning models corresponding to the sample subset through the K-fold cross-validation method, and obtaining the predicted values of the plurality of machine learning models for the sample subset, reference may be made to the description above in conjunction with FIG. 2, and the details are not described here.

In some embodiments, the sample feature fusion module 430 may be further configured to: take the predicted value of each machine learning model for each sample as a feature value of the corresponding dimension of the sample, so as to obtain a fusion sample corresponding to the sample.

In some embodiments, the sampling module 410 may be further configured to: perform random sampling on the sample set to obtain at least one sample subset, and perform feature sampling on each sample subset.

In some embodiments, the plurality of machine learning models are different types of machine learning models.

According to the model training apparatus disclosed by the embodiment of the present application, at least one sample subset is obtained by sampling a sample set; then, for each of the sample subsets, a plurality of machine learning models corresponding to the sample subset are respectively trained according to the sample subset, and predicted values of the plurality of machine learning models for the sample subset are obtained; a fusion sample set is determined according to the predicted values of the machine learning models for each of the sample subsets: and finally, a target machine learning model is trained according to the fusion sample set, thereby solving the problem of inaccurate predicted result when the trained models are applied to data mining, data searching, and the like. According to the model training apparatus disclosed by the embodiment of the present application, a sample set is divided into a plurality of sample subsets to train different machine learning models, and then, the predicted result of the model obtained by previous training on the training data is taken as the feature of the training data to further perform training, thereby effectively avoiding the problem of inaccurate predicted result of the model obtained by training due to a single training model or uneven training data distribution, and effectively improving the accuracy of the prediction effect of the model obtained by training.

A single machine learning model is trained through K-fold cross-validation to obtain the predicted values of the single machine learning model for the training data and the predicted values of the single machine learning model for test data, and then, feature fusion is performed on the training data based on the obtained predicted values, thereby improving the accuracy of the predicted result of the target machine learning model.

By performing a certain depth of iteration training, the problem of inaccurate prediction of the model obtained by training due to a single model may be further avoided, and the prediction effect of the model may be further improved.

Some embodiments in accordance with the disclosure provide an electronic device. The electronic device includes a memory, a processor, and a computer program that is stored on the memory and that can run on the processor, and the processor executes the computer program to implement the foregoing model training method in this application. The electronic device may be a personal computer (PC), a mobile terminal, a personal digital assistant, a tablet computer, or the like.

Some embodiments in accordance with the disclosure can provide a computer-readable storage medium, storing a computer program, and when the program is executed by the processor, steps of the foregoing model training method in the present application being implemented.

The embodiments in this specification are all described in a progressive manner. Descriptions of each embodiment focus on differences from other embodiments, and same or similar parts among respective embodiments may be mutually referenced. The apparatus embodiments are substantially similar to the method embodiments and therefore are only briefly described, and reference may be made to the method embodiments for the corresponding sections.

The model training method and apparatus provided in the present application are described in detail above. The principle and implementations of the present application are described herein by using specific examples. The descriptions of the foregoing embodiments are merely used for helping understand the method and core ideas of this application. In addition, a person of ordinary skill in the art can make variations to the present application in terms of the specific implementations and application scopes according to the ideas of this application. Therefore, the content of this specification shall not be construed as a limit on this application.

Through the description of the foregoing implementations, a person skilled in the art may understand that the implementations may be implemented by software in addition to a necessary universal hardware platform, or by hardware, or by hardware. Based on such an understanding, the foregoing technical solutions essentially or the part contributing to the prior art may be implemented in a form of a software product. The computer software product may be stored in a computer readable storage medium, such as a ROM/RAM, a hard disk, or an optical disc, and includes several instructions for instructing a computer device (which may be a personal computer, a server, a network device, or the like) to perform the methods described in the embodiments or some parts of the embodiments.

1. A method of training a model, comprising:
obtaining one or more sample subsets according to a sample set;
for each of the sample subsets, training a plurality of machine learning models corresponding to the sample subset according to the sample subset, and obtaining predicted values of the plurality of machine learning models for the sample subset;
determining a fusion sample set according to the predicted values of the machine learning models for each of the sample subsets; and
training a target machine learning model according to the fusion sample set.

2. The method according to claim 1, wherein the training of the target machine learning model according to the fusion sample set comprises:
obtaining one or more fusion sample subsets according to the fusion sample set;
for each of the fusion sample subsets, respectively taking the fusion sample subset as input of a plurality of fusion machine learning models, training the plurality of fusion machine learning models corresponding to the fusion sample subset, and obtaining predicted values of the plurality of fusion machine learning models for the fusion sample subset;
determining a target sample set according to the predicted values of the fusion machine learning models for each of the fusion sample subsets; and
training a target machine learning model according to the target sample set.

3. The method according to claim 2, further comprising:
before determining the target sample set according to the predicted values of the fusion machine learning models for each of the fusion sample subsets,
if the number of times of training the fusion machine learning models is less than a preset value, returning to the obtaining of the one or more fusion sample subsets according to the fusion sample set to train the fusion machine learning models again and update the predicted values of the fusion machine learning models for each of the fusion sample subsets; and
if the number of times of training the fusion machine learning models is greater than or equal to the preset value, proceeding to the determining of the target sample set according to the predicted values of the fusion machine learning models for each of the fusion sample subsets.

4. The method according to claim 1, wherein the training f the plurality of machine learning models corresponding to the sample subset according to the sample subset, and obtaining the predicted values of the plurality of machine learning models for the sample subset comprises:
taking the sample subset as input of the plurality of machine learning models, training the plurality of machine learning models corresponding to the sample subset through a K-fold cross-validation method, and obtaining the predicted values of the plurality of machine learning models for the sample subset.

5. The method according to claim 1, wherein the determining of the fusion sample set according to the predicted values of the machine learning models for each of the sample subsets comprises:
for each sample in the sample set, taking the predicted value of each of the machine learning models for the sample as a feature value of the corresponding dimension of the sample, so as to obtain a fusion sample corresponding to the sample; and
forming the fusion sample set by all of the fusion samples.

6. The method according to claim 1, wherein the obtaining of the one or more sample subsets according to the sample set comprises:
performing random sampling on the sample set to obtain the one or more sample subsets; and
performing feature sampling on each of the sample subsets.

7. The method according to claim 1, wherein the plurality of machine learning models are different types of machine learning models.

8. (canceled)

9. An electronic device, comprising
a processor and
a memory, for storing a computer program that is executable by the processor to perform operations comprising:
obtaining one or more sample subsets according to a sample set;
for each of the sample subsets, respectively training a plurality of machine learning models corresponding to the sample subset according to the sample subset, and obtaining predicted values of the plurality of machine learning models for the sample subset;
determining a fusion sample set according to the predicted values of the machine learning models for each of the sample subsets; and
training a target machine learning model according to the fusion sample set.

10. A non-transitory computer readable storage medium, wherein a computer program is stored on the computer readable storage medium, and when the program is executed by a processor, the method of training the model according to claim 1 is implemented.

11. The method according to claim 2, wherein the respectively training of the plurality of machine learning models corresponding to the sample subset according to the sample subset, and obtaining the predicted values of the plurality of machine learning models for the sample subset comprises:
respectively taking the sample subset as input of the plurality of machine learning models, training the plurality of machine learning models corresponding to the sample subset through a K-fold cross-validation method, and obtaining the predicted values of the plurality of machine learning models for the sample subset.

12. The method according to claim 3, wherein the respectively training of the plurality of machine learning models corresponding to the sample subset according to the sample subset, and obtaining the predicted values of the plurality of machine learning models for the sample subset comprises:
respectively taking the sample subset as input of the plurality of machine learning models, training the plurality of machine learning models corresponding to the sample subset through a K-fold cross-validation method, and obtaining the predicted values of the plurality of machine learning models for the sample subset.

13. The method according to claim 2, wherein the determining of the fusion sample set according to the predicted values of the machine learning models for each of the sample subsets comprises:
for each sample in the sample set, taking the predicted value of each of the machine learning models for the sample as a feature value of the corresponding dimension of the sample, so as to obtain a fusion sample corresponding to the sample; and
forming the fusion sample set by all of the fusion samples.

14. The method according to claim 3, wherein the determining of the fusion sample set according to the predicted values of the machine learning models for each of the sample subsets comprises:
for each sample in the sample set, taking the predicted value of each of the machine learning models for the sample as a feature value of the corresponding dimension of the sample, so as to obtain a fusion sample corresponding to the sample; and
forming the fusion sample set by all of the fusion samples.

15. The device according to claim 9, wherein the training of the target machine learning model according to the fusion sample set comprises:
obtaining at least one fusion sample subset according to the fusion sample set;
for each of the fusion sample subsets, respectively taking the fusion sample subset as input of a plurality of fusion machine learning models, training the plurality of fusion machine learning models corresponding to the fusion sample subset, and obtaining predicted values of the plurality of fusion machine learning models for the fusion sample subset;
determining a target sample set according to the predicted values of the fusion machine learning models for each of the fusion sample subsets; and
training a target machine learning model according to the target sample set.

16. The device according to claim 15, wherein the operations further comprise:
before determining the target sample set according to the predicted values of the fusion machine learning models for each of the fusion sample subsets,
if the number of times of training the fusion machine learning models is less than a preset value, returning to the obtaining of the one or more fusion sample subsets according to the fusion sample set, so as to train the fusion machine learning models again and update the predicted values of the fusion machine learning models for each of the fusion sample subsets; and
if the number of times of training the fusion machine learning models is greater than or equal to the preset value, proceeding to the determining of the target sample set according to the predicted values of the fusion machine learning models for each of the fusion sample subsets.

17. The device according to claim 9, wherein the respectively training of the plurality of machine learning models corresponding to the sample subset according to the sample subset, and obtaining the predicted values of the plurality of machine learning models for the sample subset comprises:
respectively taking the sample subset as input of the plurality of machine learning models, training the plurality of machine learning models corresponding to the sample subset through a K-fold cross-validation method, and obtaining the predicted values of the plurality of machine learning models for the sample subset.

18. The device according to claim 9, wherein the determining of the fusion sample set according to the predicted values of the machine learning models for each of the sample subsets comprises:
for each sample in the sample set, taking the predicted value of each of the machine learning models for the sample as a feature value of the corresponding dimension of the sample, so as to obtain a fusion sample corresponding to the sample; and
forming the fusion sample set by all of the fusion samples.
